(19) United States
(12) Patent Application Publication
(10) Pub. No.: US 2014/0225481 A1
(43) Pub. Date: Aug. 14, 2014

(54) NOISE REDUCING FEATURES ON COOLING FAN

(71) Applicant: Remy Technologies LLC, Pendleton, IN (US)

(72) Inventors: James Paul Murphy, Greenfield, IN (US); Kirk Neet, Pendleton, IN (US); Chad Zook, Anderson, IN (US)

(73) Assignee: Remy Technologies LLC, Pendleton, IN (US)

(21) Appl. No.: 14/178,832

(22) Filed: Feb. 12, 2014

Related U.S. Application Data
(60) Provisional application No. 61/763,810, filed on Feb. 12, 2013.

(51) Int. Cl. H02K 9/06; H02K 3/52

(52) U.S. Cl. CPC H02K 9/06; H02K 3/525
USPC 310/60 R

(57) ABSTRACT

A rotor arrangement for an electric machine includes a rotor shaft extending in an axial direction and a fan coupled to the rotor shaft. The fan includes a face with a plurality of arcuate walls extending from the face in the axial direction. Each of the plurality of arcuate walls includes a first end portion and a second end portion. A plurality of radial tines extend from the first end portion of each arcuate wall. A plurality of axial tines extending from the second end portion of each arcuate wall.

### CROSS-REFERENCE TO RELATED APPLICATIONS

This document claims priority from U.S. Provisional Patent Application Ser. No. 61/763,810, filed Feb. 12, 2013.

### FIELD

This application relates to the field of vehicle electric systems and more particularly, to internal cooling fans used on electro-mechanical machines, such as alternators.

### BACKGROUND

Electric motors and generators are commonly used in automotive applications. These electric motors and generators are exposed to significant amounts of heat, including heat generated by the device itself as well as other devices within the engine compartment. Accordingly, electric motors and generators are often equipped with fans configured to deliver or draw a flow of cooling air across the windings, heat sinks, electronics, and other components of the electric machine. On alternators, these fans may include both a front end fan and a rear end fan, as is well known to those of ordinary skill in the field of vehicle electric machines. Front end fans are often configured to generate airflow in both an axial and a radial direction. Rear end fans are often configured to generate airflow in a predominantly radial direction. An example of such fans is shown in U.S. Patent Publication No. 2011/0316369, the content of which is incorporated herein by reference.

While fans are effective in cooling electric machines in automotive engine compartments, conventional fans also produce a significant amount of noise as a result of the air turbulence created by the fan blades. This noise can be heard by those in close proximity to the vehicle, including those riding inside of the vehicle cabin. This excessive noise is generally considered an undesirable feature as owners of automobiles and other vehicles typically prefer for the vehicle to be as quiet as possible. Accordingly, it is desirable to utilize noise reducing features in association with vehicle electric machine fans.

In view of the foregoing, it would be desirable to provide a fan for a vehicle electric machine that is effective for cooling purposes while also reducing air turbulence in order to reduce the noise produced by the fan during operation. It would also be desirable for such a fan to be generally inexpensive to produce and easily incorporated onto existing electric machine designs.

### SUMMARY

In at least one embodiment, a rotor arrangement for an electric machine includes a rotor shaft extending in an axial direction and a fan coupled to the rotor shaft. The fan includes a face with a plurality of arcuate walls extending from the face in the axial direction. Each of the plurality of arcuate walls includes a first end portion and a second end portion. A plurality of radial tines extend from the first end portion of each arcuate wall. A plurality of axial tines extending from the second end portion of each arcuate wall.

In at least one alternative embodiment, an electric machine comprises a field winding with a plurality of claw-pole segments arranged around the field winding. The electric machine further comprises a rotor shaft coupled to the plurality of claw-pole segments. The rotor shaft defines a shaft axis about which the rotor shaft rotates. A fan is coupled to the rotor shaft. The fan includes a face with a plurality of walls extending from the face in the axial direction. Each of the plurality of walls include a first end portion and a second end portion with a step between the first end portion and the second end portion. A plurality of axial tines extend from the second end portion. The plurality of axial tines are positioned along a length of each wall following the step with the height of each axial tine about the same as the height of the step.

In at least one alternative embodiment, a rotor arrangement for an electric machine includes a rotor shaft extending in an axial direction and a fan coupled to the rotor shaft. The fan includes a main body portion with a plurality of walls extending from the main body portion in the axial direction. Each of the plurality of walls includes a plurality of radial tines and a plurality of axial tines. The plurality of radial tines extend from a first portion of each of the plurality of walls. The plurality of axial tines extend from a second portion of each of the plurality of walls.

The above described features and advantages, as well as others, will become more readily apparent to those of ordinary skill in the art by reference to the following detailed description and accompanying drawings. While it would be desirable to provide an electric machine that provides one or more of these or other advantageous features as may be apparent to those reviewing this disclosure. The teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a top perspective view of a fan including fan blades with noise reducing features provided by comb features on the fan blades;

FIG. 2 shows a side perspective view of the fan of FIG. 1;

FIG. 3 shows an top isolation view of one of the fan blades of FIG. 1 including the comb features;

FIG. 4 shows the fan of FIG. 1 positioned on a rotor arrangement of a vehicle electric machine; and

FIG. 5 shows an alternate embodiment of the fan of FIG. 1.

### DESCRIPTION

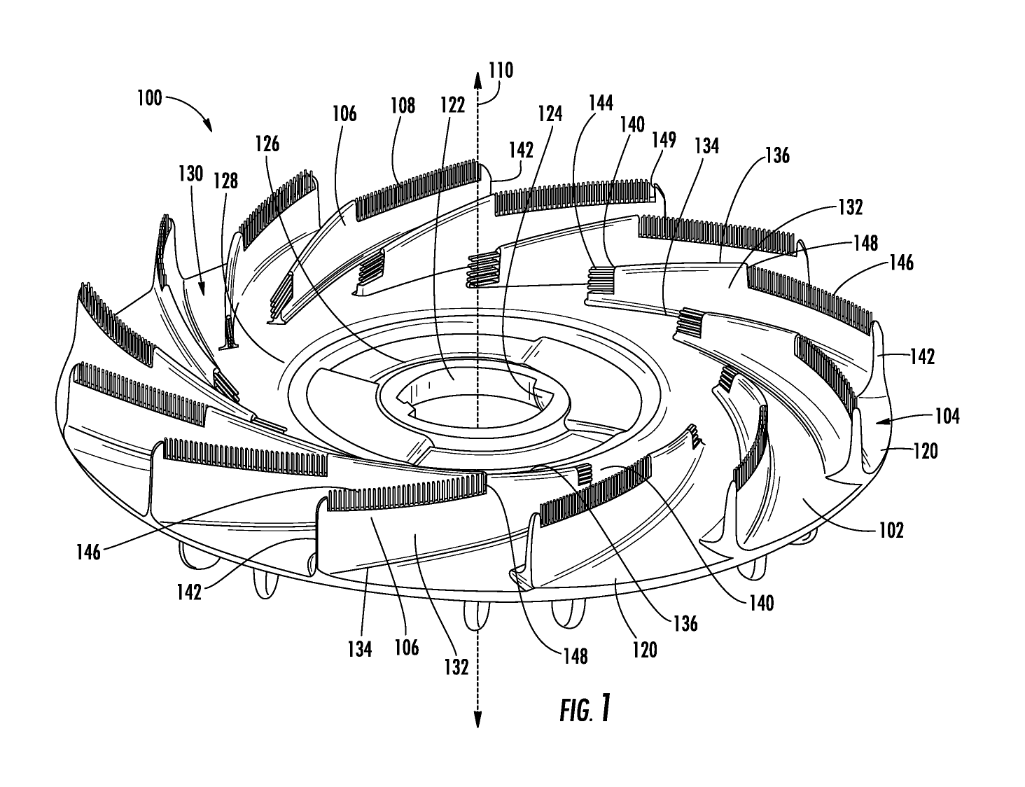

With reference to FIG. 1, a fan 100 for a vehicle electric machine includes a disc member 102 with a plurality of fan blades 106 provided on the face 104 of the disc member 102. The fan blades 106 include a plurality of comb features 108 as explained in further detail below.

The disc member 102 includes a fan face 104 and an opposite face (not shown in FIG. 1). The disc member 102 further includes a circular outer perimeter 120 and a circular central opening 122 centered about an axis 110. The central opening 122 includes a boss 124 configured to engage a groove on a rotor shaft in order to join the disc member 102 to the rotor shaft. A central hub portion 126 and a main body portion 128 are provided between the central opening 122 and the outer perimeter 120. The central hub portion 126 includes a contoured surface on the fan face 104 that extends radially outward from the central opening 122. The main body portion 128 extends radially outward from the central hub portion 126 and includes a substantially flat surface 130 on the fan face 104. This substantially flat surface 130 surrounds the hub portion 128 and extends to the outer perimeter 120. The main body portion 128 also includes a plurality of fan blades 106 which extend outward from the substantially flat surface 130 on the fan face 104 in the axial direction.

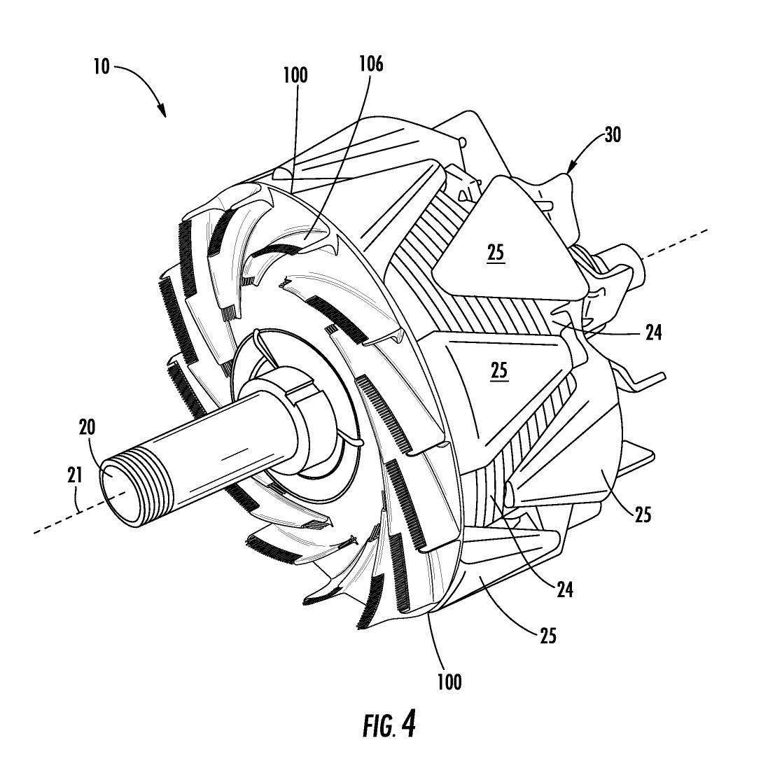

As shown in FIGS. 1-3, each fan blade 106 includes an arcuate wall 132 having a base portion 134, an upper edge 136, a first end portion 140 and a second end portion 142. The base portion 134 is integrally formed with the flat surface 130 of the main body portion 128. The upper edge 136 is opposite the base portion 134 in the axial direction, and is free from contact with any components other than being part of the arcuate wall 132. The arcuate wall 132 is generally tapered in an axial direction such that the base portion 134 is thicker than the upper edge 136.

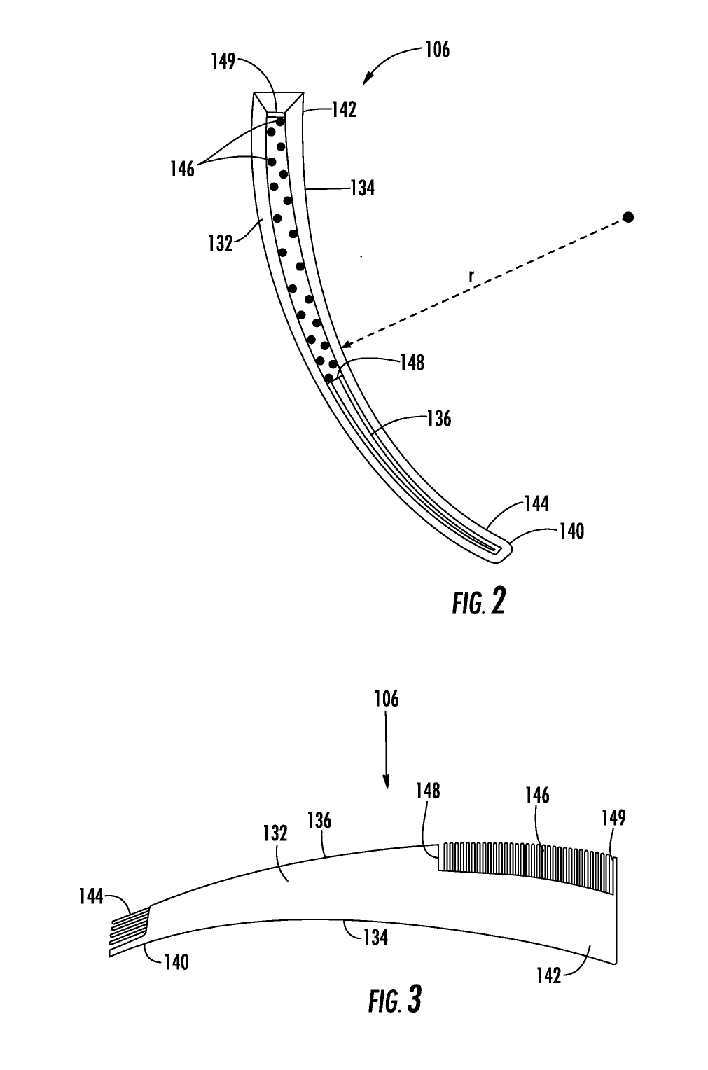

The first end portion 140 of the arcuate wall 132 is positioned on the main body portion 128 closer to the central hub portion 126 than the outer perimeter 120 of the disc member 102. The second end portion 142 of the arcuate wall 132 extends to the outer perimeter 120 of the disc member 102. Thus, the second end portion 142 of the arcuate wall 132 is positioned radially outward from the first end portion 140 of the arcuate wall 132. The arcuate wall 132 curves between the first end 140 and the second end 142, as defined by a radius of curvature r shown in FIG. 2. Additionally, the arcuate wall 132 gradually ramps upward (i.e., away from the fan face 104) from the first end 140 to the second end 142 such that the arcuate wall 132 is shorter at the first end 140 than at the second end 142. For example, at least one embodiment the arcuate wall 132 is about 7 mm in height at the first end 140 and about 21 mm in height at the second end 142.

In the embodiment of FIGS. 1-3, comb features 108 are provided on both the first end portion 140 and the second end portion 142 of each fan blade 106. Each comb feature is a slender elongated projection or “tine” that extends from the arcuate wall 132. The comb features 108 include radial tines 144 that extend in a substantially radial direction from the first end portion 140 of the fan blade 106. The comb features 108 also include axial tines 146 that extend in a substantially axial direction along the upper edge 136 of the arcuate wall 132 at the second end portion 142 of the fan blade 106.

The radial tines 144 are provided in two rows that extend from the first end portion 140 of the arcuate wall 132. The radial tines 144 are configured such that at least one of the radial tines 144 extends radially outward near the top of the arcuate wall 132. As a result, the arcuate wall 132 appears to be at least partially continued at the first end 140 by the radial tines 144. Six to twelve radial tines 144 are included on each fan blade 106. Each radial tine 144 is substantially cylindrical in shape. In at least one embodiment, each radial tine 144 is less than 3 mm in diameter, and between about 0.5 mm and 6 mm in length. Furthermore, in at least the embodiment of FIGS. 1-3, the diameter of the tine is substantially consistent along the substantial length of the tine. For example, if the diameter of the tine is 0.5 mm and the length of the tine is 3.0 mm, the 0.5 mm diameter will be substantially the same along most of the 3.0 mm length of the tine from a base of the tine to a tip of the tine. Accordingly, in at least one embodiment, the diameter of the tine does not vary by more than 25% from a first position at the base of the tine to a second position at the tip of the tine.

While the radial tines 144 have been disclosed herein as being substantially cylindrical in shape in the disclosed embodiment, it will be recognized that other shapes of tines may be implemented in other embodiments. For example, the radial tines 144 may be provided by an elongated member having a rectangular, square, or triangular cross-section. Furthermore, while the radial tines 144 have been disclosed as having a substantially consistent diameter along the length of the tine, in other embodiments, the diameter of the tine may vary substantially along the length, such as the varying diameter associated with an ornamental baluster. Additionally, it will be recognized that in some embodiments the tines may include sharp or pointed tips, but in other embodiments the tips may be relatively blunt with substantially the same diameter at both the tip and the base of the tine.

The axial tines 146 are positioned along approximately half of the length of the arcuate wall 132, extending from a first step 148 near the midpoint of the arcuate wall 132 to a second step 149 at the second end 142 of the arcuate wall 132. As best shown in FIG. 2, the axial tines 146 are positioned in two staggered rows of tines 146 along the upper edge 136. The step 148 near the midpoint of the arcuate wall 132 results in the axial tines 146 being recessed on the arcuate wall 132, with the tips of the axial tines 146 providing a substantially even upper edge 136 to the arcuate wall. A slight slope in the arcuate wall 132 can be seen from the first end portion 140 to the second end portion 142. This slight slope begins at the upper edge 136 of the first end portion 140, extends across the tips of the axial tines 146, and ends after the second step 149 at the second end portion 142. Twenty to forty axial tines 146 are included on each fan blade 106. Each axial tine 146 is substantially cylindrical in shape. In at least one embodiment, each axial tine 146 is less than 3.0 mm in diameter, and between about 0.5 mm and 6 mm in length. Furthermore, in at least the embodiment of FIGS. 1-3, the diameter of the tine is substantially consistent along the substantial length of the time. For example, if the diameter of the tine is 0.5 mm and the length is 3.0 mm, the 0.5 mm diameter will be substantially the same along most of the 3.0 mm length of the tine, from a base of the tine to a tip of the tine. Accordingly, in at least one embodiment, the diameter of the tine does not vary by more than 25% from a first position at the base of the tine to a second position at the tip of the tine.

While the axial tines 146 have been disclosed herein as being substantially cylindrical in shape in the disclosed embodiment, it will be recognized that other shapes of tines may be implemented in other embodiments. For example, the axial tines 146 may be provided by an elongated member having a rectangular, square, or triangular cross-section. Furthermore, while the axial tines 146 have been disclosed as having a substantially consistent diameter along the length of the tine, in other embodiments, the diameter of the tine may vary substantially along the length, such as the varying diameter associated with an ornamental baluster. Additionally, it will be recognized that in some embodiments the tines may include sharp or pointed tips, but in other embodiments the tips may be relatively blunt with substantially the same diameter at both the tip and the base of the tine.

The fan 100 is manufactured from a polymer material such as PVC or any of various other polymer materials appropriate for use as a fan blade, as will be recognized by those of ordinary skill in the art. Accordingly, the fan 100 may be formed in an inexpensive manner by injection molding or another appropriate molding process. The comb features 108 on the fan 100 are preferably as thin as manufacturing processes and engineering requirements will allow. In at least one embodiment, the comb features are between ¼ mm and two mm in thickness. For example, in at least one embodiment, the comb features are about ½ mm in thickness. The length (or “height”) of the comb features may depend in part on the thickness. In at least one embodiment, the comb features are between two mm and eight mm in length. For example, in at least one embodiment, the comb features are about three mm in length.

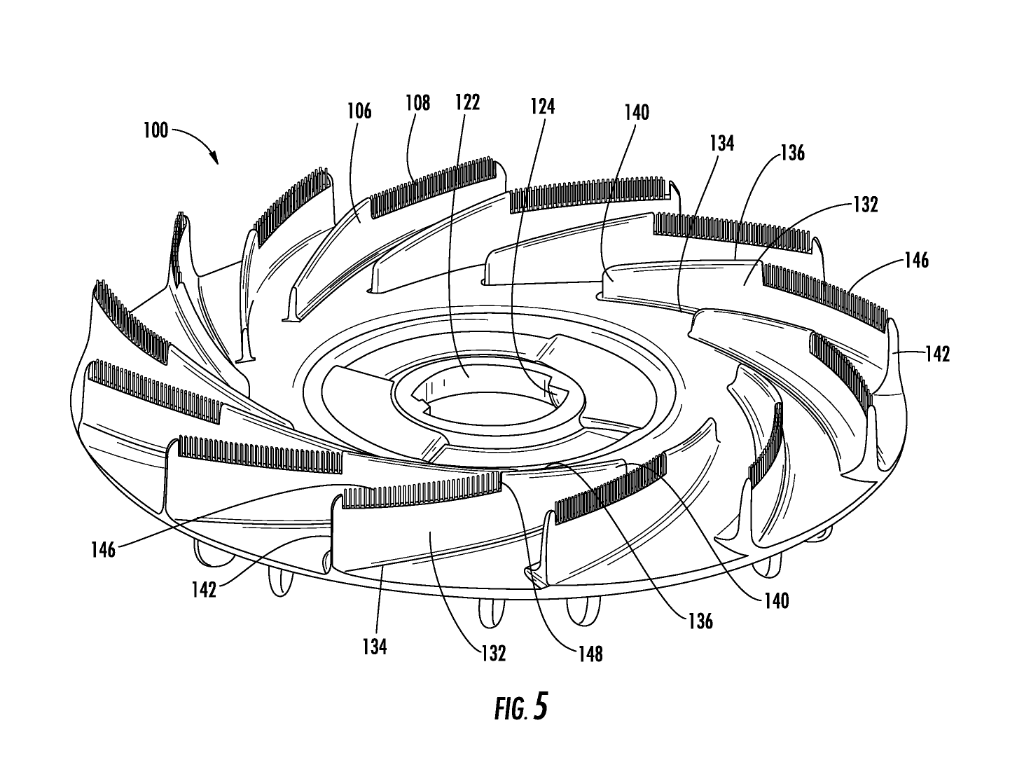

FIG. 4 shows an embodiment of the fan 100 in use on a rotor arrangement 10 for a vehicle electric machine such as an alternator. The rotor arrangement 10 includes a plurality of claw-pole segments 25 and a field winding 24. The claw-pole segments 25 are located around the field winding 24. The claw-pole segments 25 are arranged around the field winding 24 and on opposite sides of the field winding 24 such that the segments 25 mesh together, as will be recognized by those of ordinary skill in the art. The claw-pole segments 25 are coupled to a rotor shaft 20. The rotor shaft 20 defines a shaft axis 21 about which the rotor shaft 20 rotates within the machine. The shaft axis 21 is coaxial with the fan axis 110. The coupling of the claw-pole segments 25 to the rotor shaft 20 may be accomplished by any of various methods as will be recognized by those of ordinary skill in the art. The fan 100 is used in the embodiment of FIG. 4 as a rear end fan for the alternator. In addition, a front end fan 30 may also be used on the rotor arrangement.

With reference now to FIG. 5, an alternative embodiment of the fan 100 is shown. The embodiment of FIG. 5 is substantially identical to that of FIG. 1, except the radial tines 144 are not included in the embodiment of FIG. 5. Instead, the arcuate wall 132 simply terminates at the first end portion 140 of the fan blade 106 in the embodiment of FIG. 5 with no radial tines provided on the first end portion 140.

In operation, the fan 100 is provided on a rotor arrangement of an electric machine. For example, the fan 100 may be used as the rear end fan for a split rear end alternator. When the rotor of the electric machine rotates, the fan blows air away from the rotor in a radial direction (i.e., moving air from the first end portion 140 to the second end portion 142 of each fan blade and then radially outward from the fan 100). The comb features 108 on the fan 100 create reduced air turbulence as the fan rotates. This reduced air turbulence breaks up the orders of noise, resulting in quieter fan operation.

Although the present invention has been described with respect to certain exemplary embodiments, it will be appreciated by those of skill in the art that other implementations and adaptations are possible. For example, the comb features could be differently configured and arranged on the fan blades. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A rotor arrangement for an electric machine comprising:
a rotor shaft extending in an axial direction; and
a fan coupled to the rotor shaft, the fan including a face with a plurality of walls extending from the face in the axial direction, each of the plurality of walls including:
a first end portion and a second end portion; and
a plurality of axial tines extending from the second end portion.

2. The rotor arrangement of claim 1 wherein the plurality of axial tines are positioned along an upper edge of each of the plurality of walls.

3. The rotor arrangement of claim 2 wherein the plurality of axial tines are positioned in staggered rows along the upper edge of each of the plurality of walls.

4. The rotor arrangement of claim 1 wherein the plurality of axial tines are positioned along a length of each wall following a step on the wall.

5. The rotor arrangement of claim 4 wherein the plurality of axial tines extend from the step on the wall to an end of the wall.

6. The rotor arrangement of claim 5 wherein the step is located at about a midpoint of the wall.

7. The rotor arrangement of claim 6 wherein the plurality of axial tines are positioned along about half of each wall from the step on the wall to the end of the wall.

8. The rotor arrangement of claim 4 wherein the length of each tine is about the same as a height of the step.

9. The rotor arrangement of claim 1 wherein the plurality of axial tines are positioned along a length of each wall from a step on the wall to an end of the wall.

10. The rotor arrangement of claim 9 wherein each of the walls is arcuate in shape and tapered in the axial direction.

11. The rotor arrangement of claim 1 wherein the first end portion is closer to a hub of the fan than a perimeter of the fan.

12. The rotor arrangement of claim 1 further comprising a plurality of radial tines extending from the first end portion of each of the plurality of walls.

13. The rotor arrangement of claim 12, the radial tines provided in two rows that extend from the first end portion of the wall.

14. An electric machine comprising:
a field winding;
a plurality of claw-pole segments arranged around the field winding;
a rotor shaft coupled to the plurality of claw-pole segments, the rotor shaft defining a shaft axis about which the rotor shaft rotates; and
a fan coupled to the rotor shaft, the fan including a face with a plurality of walls extending from the face in an axial direction, each of the plurality of walls including:
a first end portion and a second end portion with a step between the first end portion and the second end portion; and
a plurality of axial tines extending from the second end portion, the plurality of axial tines positioned along a length of each wall following the step with a length of each axial tine about the same as a height of the step.

15. The electric machine of claim 14 wherein the plurality of axial tines extend from the step on the wall to an end of the wall.

16. The electric machine of claim 15 wherein the step is positioned at an approximate midpoint on the wall.

17. The electric machine of claim 14 further comprising a plurality of radial tines extending from the first end portion of each of the plurality of walls, the plurality of radial tines extending in a direction substantially perpendicular to the plurality of axial tines.

18. The electric machine of claim 17 wherein the length of each axial tine is about the same as the length of each radial tine.

19. The electric machine of claim 18 wherein each of the plurality of walls is arcuate in shape and tapered in an axial direction.

20. A rotor arrangement for an electric machine comprising:
a rotor shaft extending in an axial direction; and
a fan coupled to the rotor shaft, the fan including a main body portion with a plurality of walls extending from the main body portion in the axial direction, each of the plurality of walls including a plurality of tines extending from the wall, the tines positioned either (i) on an axial end of the wall and extending in the axial direction, or (ii) on a radial end of the wall and extending in a radial direction.
